(19) United States
(12) Patent Application Publication
(10) Pub. No.: US 2013/0157586 A1
(43) Pub. Date: Jun. 20, 2013

(54) WIRELESS COMMUNICATION APPARATUS AND CONTROL METHOD THEREFOR

(71) Applicant: CANON KABUSHIKI KAISHA, Tokyo (JP)

(72) Inventor: Katsuo Saito, Yokohama-shi (JP)

(73) Assignee: CANON KABUSHIKI KAISHA, Tokyo (JP)

(21) Appl. No.: 13/691,168

(22) Filed: Nov. 30, 2012

(30) Foreign Application Priority Data
Dec. 16, 2011 (JP) 2011-276126
Sep. 26, 2012 (JP) 2012-212967

(51) Int. Cl. H04B 1/40

(52) U.S. Cl. CPC H04B 1/40
USPC 455/73

(57) ABSTRACT

A wireless communication apparatus for performing wireless communication using an antenna selected from a plurality of antennas. A received power detection unit detects received power received by an antenna selected from the plurality of antennas. A reflected power detection unit detects transmitted reflected power of the selected antenna. A switching unit switches an antenna used for communication to another antenna based on a variation of the received power detected by the received power detection unit and an amount of electric power of the reflected power detected by the reflected power detection unit.

### BACKGROUND OF THE INVENTION

1. Field of the Invention

The present invention relates to a wireless communication apparatus for performing wireless communication using an antenna selected from a plurality of antennas, and a control method for the wireless communication apparatus.

2. Description of the Related Art

In recent years, an electronic apparatus having a wireless communication function for a wireless LAN, Bluetooth®, or the like is spreading. The wireless LAN, Bluetooth, or the like uses a 2.5 or 5 GHz-band radio wave. The above electronic apparatus having a wireless communication function incorporates, in its housing, an antenna for wireless communication for which various antennas such as a dipole antenna, helical antenna, slot antenna, and inverted F antenna are used.

If an electronic apparatus such as a personal computer incorporates an antenna, a body may move close to the antenna. In this case, the characteristics of the antenna change to cause deterioration of the performance, and the body absorbs a radio wave emitted by the antenna. In consideration of the influence of a radio wave on a body, the standard for an SAR (Specific Absorption Rate) representing the degree of energy of a radio wave absorbed by a body is stipulated. In view of such a situation, it is required to reduce the amount of radiation of a radio wave to a body while maintaining a communication state.

FIG. 3 is a graph in which the ordinate represents a change in received power of a reception unit and the abscissa represents a communication distance. FIG. 3 shows a case in which the received power decreases as the communication distance is longer. A conventional antenna diversity scheme maintains the communication quality by switching an antenna in use to another antenna when the received power of a communication partner becomes smaller than a threshold Pth. It is a common practice not to switch the antenna when the received power is equal to or larger than the threshold Pth, because the received power level is sufficient for communication.

There is also well known a control operation of avoiding deterioration of the characteristics of the antenna due to its surrounding environment. A technique of appropriately controlling the impedance of an antenna when a body moves close to the antenna in order to avoid the influence of the body is known as Japanese Patent Laid-Open No. 2005-354502 (to be referred to as patent literature 1 hereinafter). Patent literature 1 discloses a technique in which in a wireless communication apparatus, such as a cellular phone, for transmitting/receiving data, an impedance mismatch occurring when a body moves close to the apparatus is solved to reduce a power loss due to the impedance mismatch. An adaptative control unit measures the detected value of reflected power, and reads out a phase angle and capacitance value from a storage unit, thereby adaptively controlling the phase angle and a variable capacitance capacitor based on a measurement result so that the reflected power becomes smallest.

The conventional antenna diversity scheme of ensuring the communication quality by switching an antenna does not reduce the influence of a body or an influence on the body. Furthermore, a control circuit in an antenna circuit, which solves an impedance mismatch in order to avoid the influence of the body is complicated, and the scale of the circuit around the antenna is large.

### SUMMARY OF THE INVENTION

The present invention provides a wireless communication apparatus which reduces the amount of radiation of a radio wave to a body without a complicated control operation.

The first aspect of the present invention provides a wireless communication apparatus for performing wireless communication using an antenna selected from a plurality of antennas comprising a received power detection unit which detects received power received by an antenna selected from the plurality of antennas, a reflected power detection unit which detects transmitted reflected power of the selected antenna and a switching unit which switches an antenna used for communication to another antenna based on a variation of the received power detected by the received power detection unit and an amount of electric power of the reflected power detected by the reflected power detection unit.

The second aspect of the present invention provides a wireless communication apparatus for performing wireless communication using an antenna selected from a plurality of antennas comprising a received power detection unit which detects received power received by an antenna selected from the plurality of antennas, a contact detection unit which detects contact of an object at a predetermined position from the selected antenna on a housing of the wireless communication apparatus and a switching unit which switches an antenna used for communication to another antenna based on a variation of the received power detected by the received power detection unit and a contact detection result of the contact detection unit.

The third aspect of the present invention provides a control method for a wireless communication apparatus for performing wireless communication using an antenna selected from a plurality of antennas comprising a step of switching a selected antenna to another antenna based on a variation of received power received by the selected antenna and an amount of electric power of transmitted reflected power of the selected antenna.

The fourth aspect of the present invention provides a control method for a wireless communication apparatus for performing wireless communication using an antenna selected from a plurality of antennas comprising a step of switching an antenna used for communication to another antenna based on a variation of received power received by a selected antenna and a detection result of detecting contact of an object at a predetermined position from the selected antenna on a housing of the wireless communication apparatus.

Further features of the present invention will become apparent from the following description of exemplary embodiments with reference to the attached drawings.

### BRIEF DESCRIPTION OF THE DRAWINGS

FIG. 1 is a schematic block diagram showing a wireless unit;

FIGS. 2A and 2B are flowcharts showing an antenna switching timing;

FIG. 3 is a graph for explaining general antenna diversity;

FIG. 4 is a schematic view showing a case in which a body moves close to an apparatus including a plurality of antennas;

FIG. 5 is a schematic view showing the absorption loss of a received radio wave by the body and the reflected power loss of an antenna when the body moves close to the antenna;

FIG. 6 is a graph showing the relationship between a distance from a communication partner and a change in received power when a body moves close to the antenna;

FIGS. 7A, 7B, and 7C are views showing a case wherein a body moves, from above, close to an antenna in which a change in transmitted reflected power due to the proximity of the body is large;

FIG. 8 is a graph showing the relationship between the transmitted reflected power and the distance between the body and an exterior covering;

FIG. 9 is a graph showing the relationship between a received power variation and the distance between the body and the exterior covering;

FIG. 10 is a table showing antenna switching conditions;

FIGS. 11A, 11B, and 11C are views showing a case wherein a body moves, in the horizontal direction, close to an antenna in which a change in transmitted reflected power due to the proximity of the body is large;

FIG. 12 is a graph showing the relationship between the transmitted reflected power and the distance between the body and the exterior covering;

FIG. 13 is a graph showing the relationship between a received power variation and the distance between the body and the exterior covering;

FIG. 14 is a table showing antenna switching conditions;

FIG. 15 is a graph for explaining an overview of a change in transmitted reflected power due to the proximity of a body depending on the type of antenna;

FIGS. 16A, 16B, and 16C are views showing a case wherein a body moves, from above, close to an antenna in which a change in transmitted reflected power due to the proximity of the body is small;

FIG. 17 is a graph showing the relationship between the transmitted reflected power and the distance between the body and the exterior covering;

FIG. 18 is a graph showing the relationship between a received power variation and the distance between the body and the exterior covering;

FIG. 19 is a table showing antenna switching conditions;

FIGS. 20A, 20B, and 20C are views showing a case wherein a body moves, in the horizontal direction, close to an antenna in which a change in transmitted reflected power due to the proximity of a body is small;

FIG. 21 is a graph showing the relationship between the transmitted reflected power and the distance between the body and the exterior covering;

FIG. 22 is a graph showing the relationship between a received power variation and the distance between the body and the exterior covering; and

FIG. 23 is a table showing antenna switching conditions.

### DESCRIPTION OF THE EMBODIMENTS

### First Embodiment

FIG. 4 is a schematic view showing a case in which a body moves close to an antenna 1 of a wireless communication apparatus including a plurality of antennas 1 to 4 arranged at physically different positions. In this case, a transmission radio wave from the antenna 1 radiates the body close to it, and is absorbed by the body.

At this time, the body absorbs the transmission radio wave, and also absorbs a received radio wave, thereby reducing received power. Furthermore, the resonance frequency of the antenna 1 close to the body changes due to the influence of the dielectric constant of the body, which changes the input impedance of the antenna 1, resulting in a return loss. If the body moves close to the antenna 1, the received power of the antenna decreases by the sum of the return loss of the antenna and an absorption loss by the body. As will be described below, according to the embodiment, if the amount of radiation of the radio wave to the body is determined to be equal to or larger than a given amount, an operation of switching the antenna 1 to another antenna 2, 3, or 4 is performed.

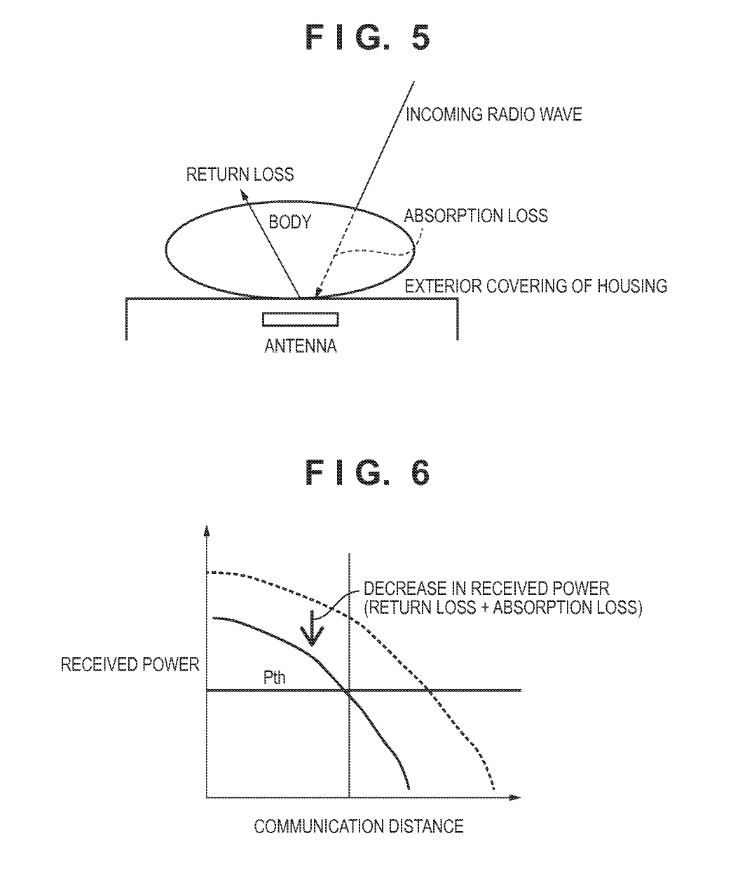

FIG. 5 is a schematic view showing the absorption loss of the received radio wave by the body and the reflected power loss of the antenna when the body moves close to the antenna.

A change in impedance of the antenna when the body moves close to it increases the transmitted reflected power of the transmission side. In this embodiment, the proximity of the body to the antenna is detected using a change in transmitted reflected power and that in received power, thereby performing antenna switching. The reason why the received power variation is used for antenna switching in addition to the transmitted reflected power of the antenna will be described below.

If the body is close to the antenna, and a hand covers the whole antenna with a given gap (space) between the hand and the antenna, the value of the transmitted reflected power is small since the antenna and the hand are spaced apart from each other to some extent. Since, however, the hand covers the whole antenna, the amount of the incoming radio wave absorbed by the hand increases. For some antennas (to be described later), transmitted reflected power does not become large even if a body moves close to the antenna to some extent. An example of such an antenna is a planar patch antenna, for which it may be impossible to determine the proximity of the body by only detecting transmitted reflected power even though the body is close to the antenna.

FIG. 6 is a graph showing the relationship between a communication distance and the received power when the state changes from a state in which the body is not close to the antenna to that in which the body is close to the antenna. FIG. 6 shows a decrease in received power which is obtained by adding the return loss and the absorption loss of the received radio wave by the body due to the proximity of the body. The received power is low when the body is close to the antenna (a solid line) as compared with a case in which the body is not close to the antenna (a broken line). Even though the body moves close to the antenna, the general reception quality can be maintained if the received power is equal to or larger than a threshold Pth. If, however, a transmission operation is performed in this state, the radio wave may additionally radiate the body.

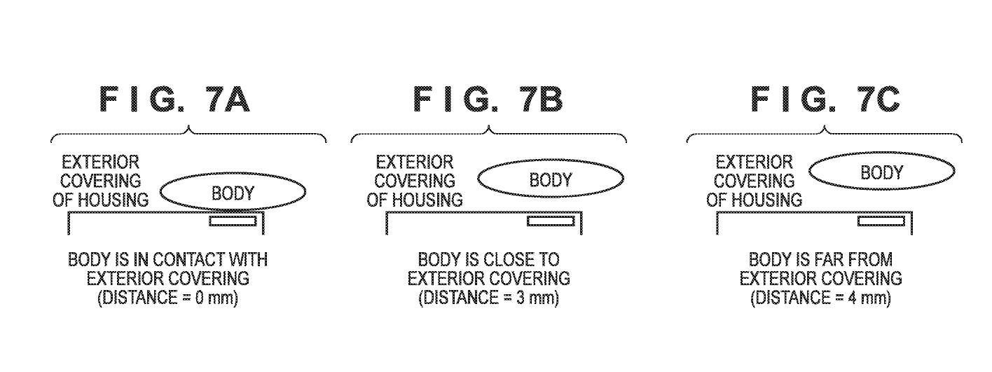

An antenna in which a change in transmitted reflected power due to the proximity of the body is relatively large will be exemplified below. FIGS. 7A to 7C show a case wherein the body moves close to the antenna arranged within the housing of the wireless apparatus in a direction in which the influence of the proximity of the body on the antenna is large. Frequencies used are a 2 GHz band and 5 GHz band. In this embodiment, a case wherein the body moves close to the antenna from above will be described. FIG. 7A shows a case wherein the body is in direct contact with an exterior covering portion on the housing on which the antenna is arranged. FIG. 7B shows a case wherein the degree of proximity of the body to the antenna is relatively high. FIG. 7C shows a case wherein the degree of proximity is low and the body is far from the antenna as compared with the case in FIG. 7B.

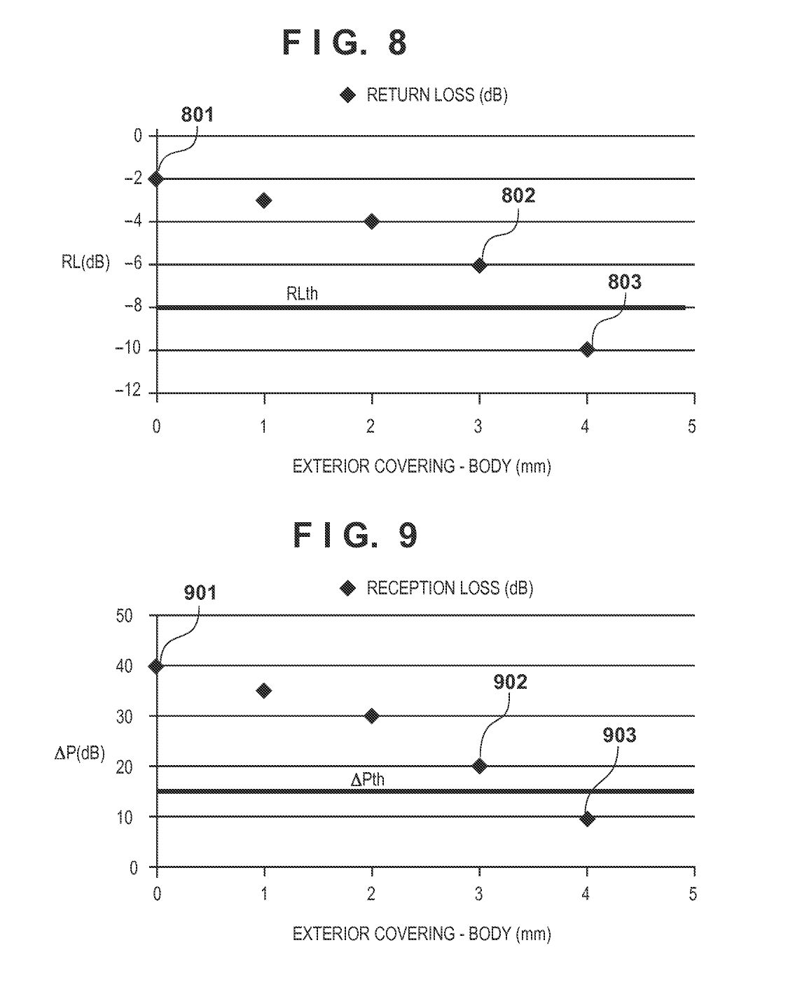

Assume, for example, that a plurality of antennas are incorporated in the housing by forming them as a pattern on a substrate (for example, monopole antennas or inverted F antennas). In this case, when the body with a high dielectric constant moves close to the housing, the resonance frequency of the antenna shifts and the characteristics in a frequency band used deteriorate. The deterioration becomes larger as the body is closer to the exterior covering of the housing incorporating the antenna. Referring to FIG. 8, the abscissa represents a distance L between the body and the exterior covering of the housing as the degree of proximity of the body to the antenna, and the ordinate represents a transmitted reflected power.

Points 801, 802, and 803 of FIG. 8 correspond to the states shown in FIGS. 7A, 7B, and 7C, respectively. Referring to FIG. 8, when the body is relatively far from the exterior covering of the housing, that is, the distance is 4 mm, the transmitted reflected power is −10 dB. When the body is relatively close to the exterior covering, that is, the distance is 3 mm, the transmitted reflected power is −6 dB. When the body is in contact with the exterior covering portion of the housing in which the antenna is arranged, that is, the distance is 0 mm, the transmitted reflected power is −2 dB.

In this embodiment, for example, a transmitted reflected power of −8 dB when the distance between the body and the exterior covering is 3.5 mm is set as a transmitted reflected power threshold RLth for antenna switching. If the transmitted reflected power is equal to or larger than the transmitted reflected power threshold RLth, it is determined that the amount of radiation to the body is large, and an operation of switching the antenna in use to another antenna is performed. When RLth=−8 dB, the transmitted reflected power is about 20% of input power. A plurality of antennas are arranged in the housing, and an antenna is switched to another antenna to reduce the amount of radiation to the body, thereby enabling to reduce the influence on the body.

Points 901, 902, and 903 of FIG. 9 correspond to the states shown in FIGS. 7A, 7B, and 7C, respectively. FIG. 9 is a graph schematically showing the relationship between the degree of proximity of the body to the antenna arranged within the housing of the wireless apparatus and a decrease in received power of an incoming radio wave. A region of an antenna element incorporated in the housing, which is covered by the body, changes depending on the distance between the body and the antenna. Since the body with a high dielectric constant as an absorption member exists between the incoming radio wave and the antenna element, the received power of the antenna element changes. As the body is closer to the antenna, the influence on the reception state of the incoming radio wave is bigger, and a variation of the received power in use is larger.

Referring to FIG. 9, the abscissa represents the distance between the body and the exterior covering of the housing incorporating the antenna element, and the ordinate represents a received power variation. The received power variation indicates that obtained when the body which is not close to the antenna moves close to it. This applies to a case in which the body in a normal reception state moves close to the housing to change the reception state. The received power variation is 10 dB (a decrease) when the body moves close to the exterior covering of the housing to a relatively long distance of 4 mm from the exterior covering. The received power variation is 20 dB when the body moves close to the exterior covering to a relative short distance of 3 mm. When the body is in almost contact with the exterior covering, that is, the distance is 0 mm, the received power variation is 40 dB.

In this embodiment, a received power variation of 15 dB when the distance between the body and the exterior covering of the housing is 3.5 mm is set as a received power variation threshold ΔPth indicating the degree of proximity of the body. If the received power variation is equal to or larger than the threshold, the antenna in use is switched to another antenna of the wireless apparatus. Assume that the body moves close to the antenna from above as shown in FIGS. 7A, 7B, and 7C. In this case, both the transmitted reflected power and the received power variation increase as the distance is shorter.

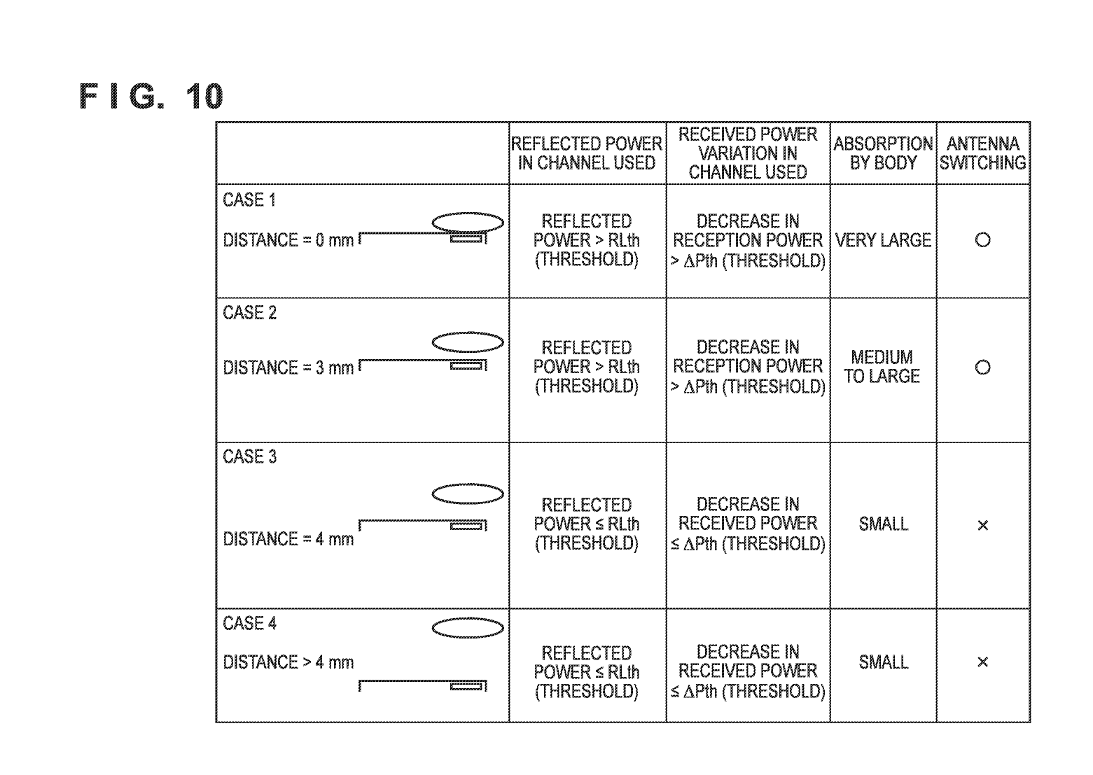

FIG. 10 is a table exemplifying antenna switching conditions when an antenna in which a change in transmitted reflected power due to the proximity of the body is relatively large is used. The table of FIG. 10 shows cases 1 to 4 in descending order of the degree of proximity of the body to the exterior covering of the housing from top to bottom. The table shows, from left to right, transmitted reflected power in a channel used, a received power variation in the channel used, the absorption degree of a radio wave by the body, and an antenna switching determination result (◯x). Assume that the received power P0 of the channel used in the initial state in which an antenna switching determination operation starts is at a sufficient level to ensure the communication quality, and is equal to or larger than Pth. If the received power P0 is smaller than Pth, an antenna switching operation is performed to ensure the communication quality irrespective of the values of the transmitted reflected power and received power variation.

In case 1, the body is in contact with the exterior covering, and the received power variation and the transmitted reflected power exceed the received power variation threshold ΔPth (a first threshold) and the transmitted reflected power threshold RLth (a second threshold), respectively. In this case, the absorption degree of the radio wave by the body is highest, and it is thus determined to switch the antenna.

In case 2, the distance between the exterior covering and the body is 3 mm. The body is not in contact with the exterior covering of the housing but is sufficiently close to it, and the transmitted reflected power and the received power variation exceed the thresholds RLth and ΔPth, respectively. In this case, it is determined that the absorption degree of the radio wave by the body is high, thereby determining to switch the antenna.

In case 3, the distance between the exterior covering and the body is 4 mm. Since the transmitted reflected power and the received power variation do not exceed the thresholds RLth and ΔPth, respectively, it is determined not to switch the antenna.

In case 4, the distance between the exterior covering and the body is longer than 4 mm. Similarly to case 3, since the transmitted reflected power and the received power variation do not exceed the thresholds RLth and ΔPth, respectively, it is determined not to switch the antenna.

To make these determinations, whether a time is equal to or longer than a predetermined time To and, whether the transmitted reflected power exceeds the threshold or whether the received power variation exceeds the threshold may be added as an antenna switching determination condition. The time To for detecting the transmitted reflected power can be different from that for detecting the received power variation for some reasons (to be described later).

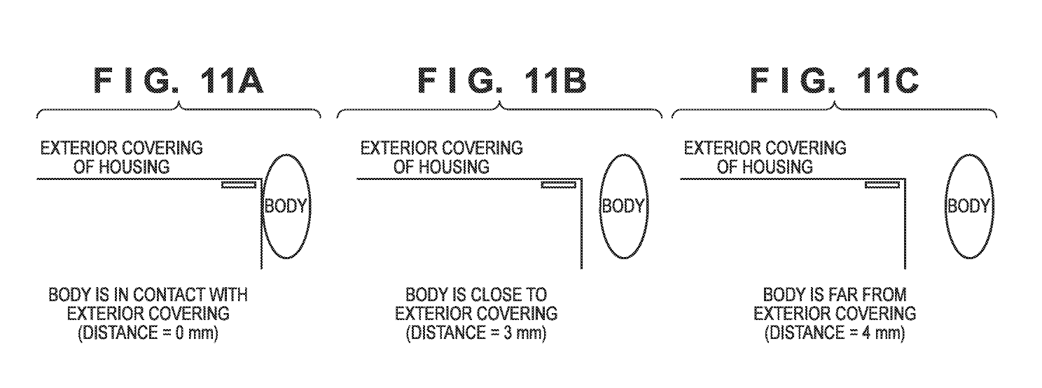

FIGS. 11A to 11C are views for explaining a case wherein a body moves close to an antenna, in which a change in transmitted reflected power due to the proximity of the body is large, in a direction in which the influence of the body on the antenna is relatively small. In this example, a body moves, in the horizontal direction, close to the antenna incorporated in the exterior covering of the housing of the wireless apparatus.

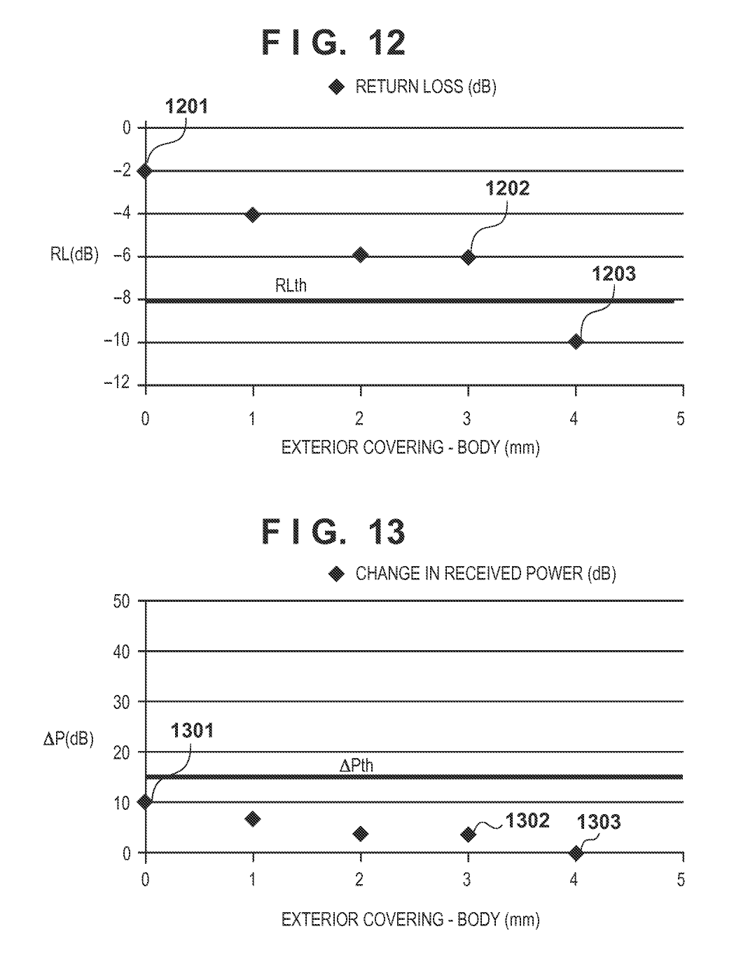

FIG. 11A shows a case in which the body is in direct contact with the exterior covering of the housing. FIG. 11B shows a case in which the degree of proximity of the body to the housing is relatively high. FIG. 11C shows a case in which the degree of proximity is low. Referring to FIG. 12, the abscissa represents the distance between the body and the exterior covering of the housing as the degree of proximity of the body to the exterior covering of the housing, and the ordinate represents the transmitted reflected power.

Points 1201, 1202, and 1203 of FIG. 12 correspond to the states shown in FIGS. 11A, 11B, and 11C, respectively. Referring to FIG. 12, when the body is relatively far from the exterior covering of the housing, that is, the distance is 4 mm, the transmitted reflected power is −10 dB. When the body is relatively close to the exterior covering, that is, the distance is 3 mm, the transmitted reflected power is −6 dB. When the body is in contact with the exterior covering, that is, the distance is 0 mm, the transmitted reflected power is −2 dB. Assume that the transmitted reflected power=−8 dB obtained when the distance between the body and the exterior covering of the housing is 3.5 mm is set as the transmitted reflected power threshold RLth. If the transmitted reflected power is equal to or larger than the transmitted reflected power threshold RLth, the amount of radiation to the body is large, and its influence on the body is a matter of concern. If, therefore, the transmitted reflected power is equal to or larger than the transmitted reflected power threshold RLth=−8 dB, the antenna in use is switched to another antenna.

Points 1301, 1302, and 1303 of FIG. 13 correspond to the states shown in FIGS. 11A, 11B, and 11C, respectively. FIG. 13 is a graph schematically showing the relationship between the degree of proximity of the body to the exterior covering of the housing of the wireless apparatus and a decrease in received power of an incoming radio wave. Referring to FIG. 13, the abscissa represents the distance between the exterior covering of the housing and the body, and the ordinate represents a received power variation when the body moves close to the exterior covering in a normal use state. In FIG. 13, the received power variation is 0 dB when the body moves close to the exterior covering of the housing to a relatively long distance of 4 mm from the exterior covering. The received power variation (a decrease) is about 4 dB even when the body is at a relative short distance of 3 mm from the exterior covering. When the body is in almost contact with the exterior covering, that is, the distance is 0 mm, the received power variation is 10 dB.

As described above, when the body moves close to the antenna in the horizontal direction in which its influence on the antenna is small, the transmitted reflected power increases as the body moves closer to the antenna, similarly to the case in which the body moves close to the antenna from above. The received power variation, however, is small unlike the case in which the body moves close to the antenna from above.

Since the transmitted reflected power exceeds the transmitted reflected power threshold RLth (−8 dB) around a distance of 3.5 mm in FIG. 12, it is identified that the body is close to the antenna. If the transmitted reflected power is equal to or larger than the transmitted reflected power threshold RLth, the amount of radiation to the body is considered to be large, and an operation of switching the antenna in use to another antenna is performed irrespective of the received power variation.

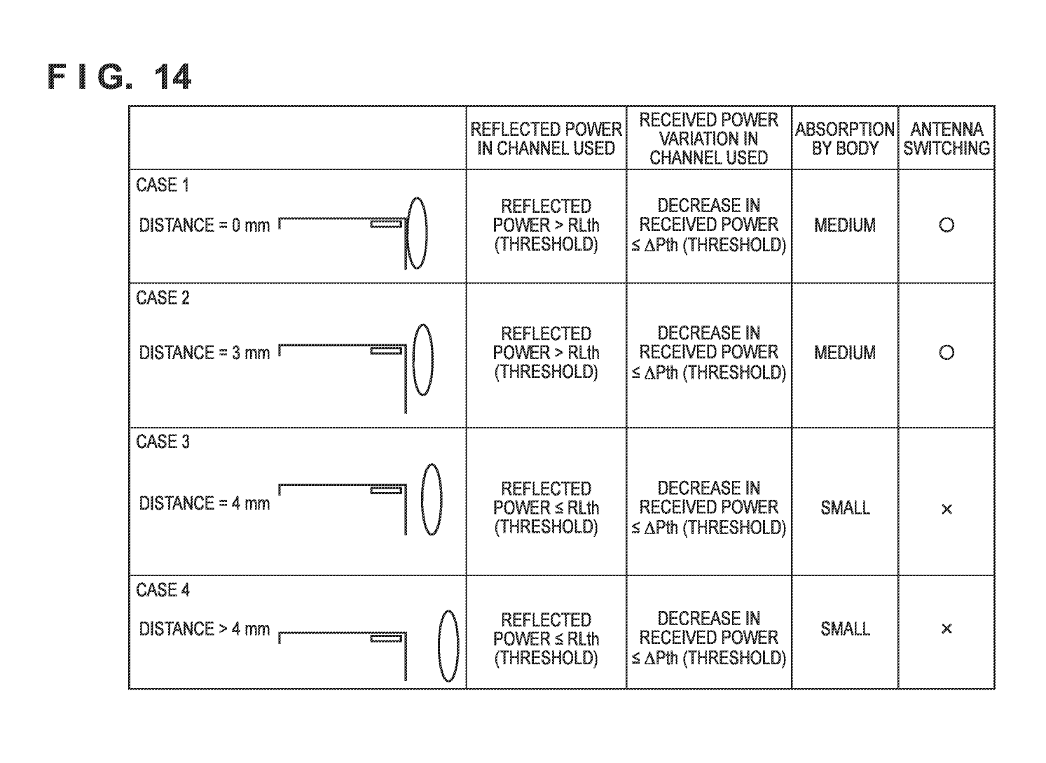

FIG. 14 is a table showing antenna switching conditions when an antenna in which a change in transmitted reflected power due to the proximity of the body is relatively large is used, and the body moves close to the exterior covering of the housing of the wireless apparatus in a direction in which its influence on the antenna is small. The table of FIG. 14 shows cases 1 to 4 in descending order of the degree of proximity of the body to the exterior covering of the housing from top to bottom.

The table shows, from left to right, transmitted reflected power in a channel used, a received power variation in the channel used, the absorption degree of a radio wave by the body, and an antenna switching determination result (◯x). Assume that the received power P0 of the channel used in the initial state in which an antenna switching determination operation starts satisfies P0≧Pth, which indicates a sufficient level to ensure the communication quality. If the received power P0<Pth, an antenna switching operation is performed to ensure the communication quality irrespective of the values of the transmitted reflected power and received power variation.

In case 1, since the distance between the exterior covering and the body is 0 mm, and the transmitted reflected power exceeds the threshold RLth, it is determined that the body is close to the exterior covering. Although the received power variation is equal to or smaller than the threshold ΔPth, it is determined to switch the antenna.

In case 2, the distance between the exterior covering and the body is 3 mm. The body is not in contact with the exterior covering of the housing but is sufficiently close to it, and the transmitted reflected power exceeds the threshold RLth, similarly to case 1. It is determined that the body is close to the exterior covering, thereby determining to switch the antenna.

In case 3, the distance between the exterior covering and the body is 4 mm and the transmitted reflected power does not exceed the threshold RLth. Since the received power variation does not exceed the threshold ΔPth, either, it is determined not to switch the antenna.

In case 4, the distance between the exterior covering and the body is longer than 4 mm. Similarly to case 3, the transmitted reflected power does not exceed the threshold RLth. Since the received power variation does not exceed the threshold ΔPth, either, it is determined not to switch the antenna.

In the above cases, whether a time is equal to or longer than a predetermined time To and, whether the transmitted reflected power exceeds the threshold or whether the received power variation exceeds the threshold may be added as a determination condition. The time To for detecting the transmitted reflected power can be different from that for detecting the received power variation. Furthermore, the antenna and a sensor for detecting contact may cooperate with each other to perform a detection operation. A sensor is arranged near each antenna to detect contact of an object at a predetermined position from the antenna. A case in which the sensor detects contact indicates that the distance is 0 mm. In this case, it is determined to switch the antenna. A sensor which can detect contact of an object, such as that for detecting a change in capacitance, can be used. If the sensor detects contact, it is possible to switch the antenna irrespective of the values of the transmitted power and received power variation, thereby solving failure of determination.

### Second Embodiment

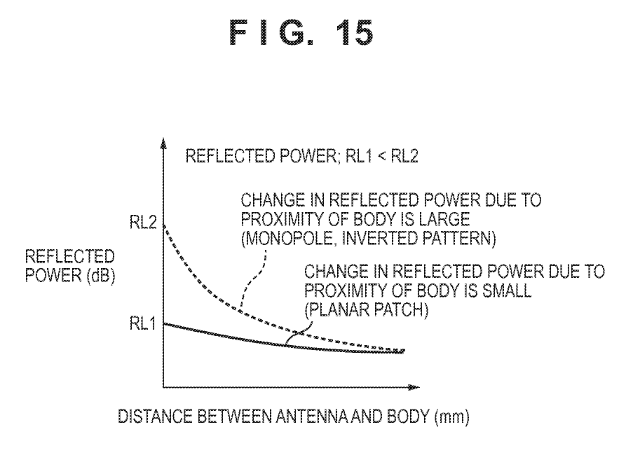

The relationship between transmitted reflected power and the distance between an antenna and a body when using an antenna in which a change in transmitted reflected power due to the proximity of the body is relatively small and an antenna in which it is relatively large will be described with reference to FIG. 15. A general pattern antenna, ceramic chip antenna, or the like presents a change in transmitted reflected power due to the proximity of the body, as indicated by a broken line. For a patch antenna or the like, however, a change in transmitted reflected power is small as indicated by a solid line even if the body moves close to the antenna. It is difficult to detect the proximity of the body to such an antenna by only detecting a change in transmitted reflected power. It is, however, possible to perform an antenna switching determination operation based on the fact that a received power variation changes as the absorption degree of a radio wave changes due to the proximity of the body.

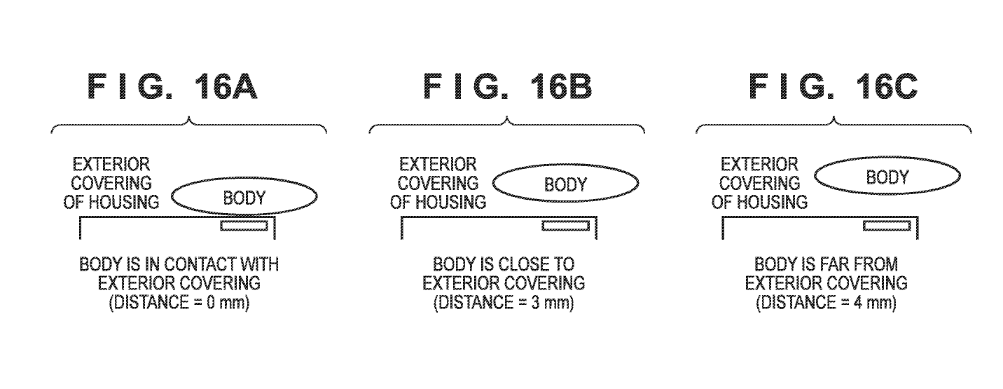

A case wherein a body moves close to the exterior covering of the housing of a wireless apparatus from above an antenna in which a change in transmitted reflected power is relatively small even if the body moves close to the antenna will be described with reference to FIGS. 16A to 16C. FIG. 16A shows a case in which the body is in direct contact with the exterior covering of the housing. FIG. 16B shows a case in which the degree of proximity of the body to the housing is relatively high. FIG. 16C shows a case in which the degree of proximity is low.

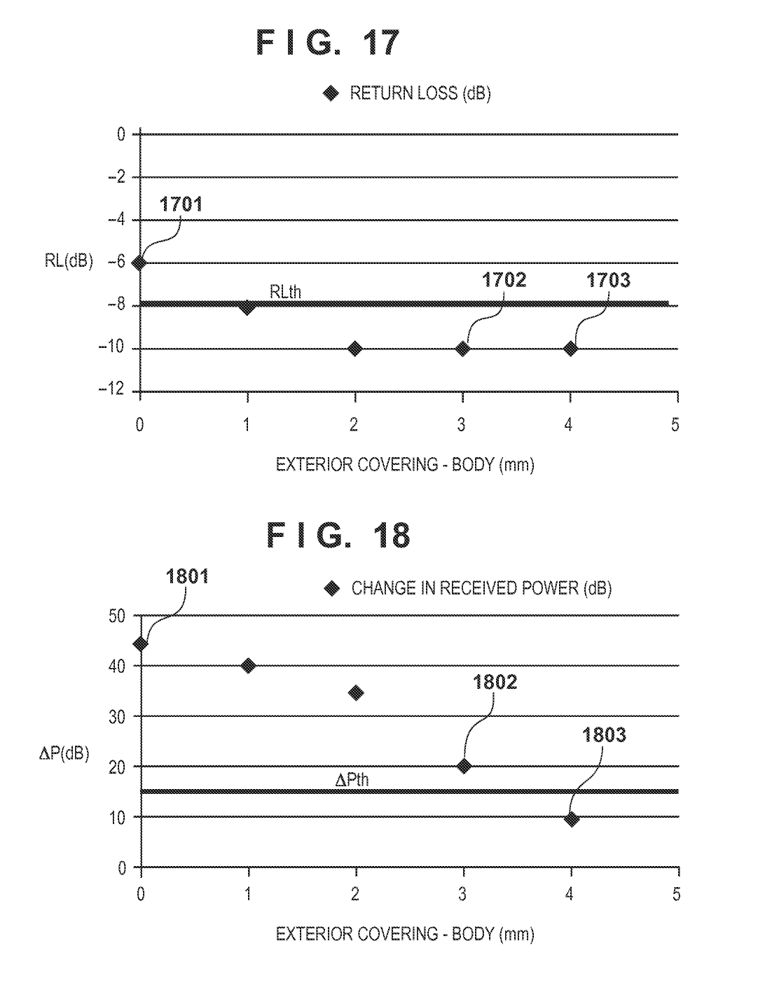

Referring to FIG. 17, the abscissa represents the distance between the body and the exterior covering of the housing as the degree of proximity of the body to the exterior covering, and the ordinate represents the transmitted reflected power. Points 1701, 1702, and 1703 of FIG. 17 correspond to the states shown in FIGS. 16A, 16B, and 16C, respectively. Referring to FIG. 17, when the body is relatively far from the exterior covering of the housing, that is, the distance is 4 mm or 3 mm, the transmitted reflected power is −10 dB. When the body is in contact with the exterior covering, that is, the distance is 0 mm, the transmitted reflected power is −6 dB.

The transmitted reflected power RLth=−8 dB when the distance between the body and the exterior covering of the housing is 1 mm is set as a transmitted reflected power threshold. If the transmitted reflected power is equal to or larger than the transmitted reflected power threshold, it is determined that there is the influence of the body, and the body absorbs a radio wave, thereby performing an operation of switching the antenna in use to another antenna. When the distance is equal to or shorter than 1 mm, the transmitted reflected power exceeds the threshold. In this case, only the transmitted reflected power may be insufficient to reduce the amount of radiation of the radio wave to the body. An antenna switching determination operation is, therefore, performed by also detecting a change in received power.

Points 1801, 1802, and 1803 of FIG. 18 correspond to the states shown in FIGS. 16A, 16B, and 16C, respectively. FIG. 18 shows the relationship between the degree of proximity of the body to the exterior covering of the housing of the wireless apparatus and a decrease in received power of an incoming radio wave. Referring to FIG. 18, the abscissa represents the distance between the exterior covering and the body, and the ordinate represents a variation of the received power with respect to that in a normal use state when the body which is not close to the antenna moves close to it. The received power variation is 10 dB when the body moves close to the exterior covering of the housing in a normal reception state to a relatively long distance of 4 mm from the exterior covering. The received power variation (decrease) is 20 dB when the body moves close to the exterior covering to a relatively short distance of 3 mm.

When the body moves to almost contact the exterior covering in the normal reception state, that is, the distance becomes 0 mm, the received power variation becomes 45 dB. In this embodiment, a received power variation of 15 dB when the distance between the body and the exterior covering of the housing is 3.5 mm is set as a received power variation threshold ΔPth (a first threshold) indicating the degree of proximity of the body. If the received power variation is equal to or larger than the threshold, the antenna in use is switched to another antenna of the wireless apparatus.

If the body moves close to the antenna from directly above as shown in FIGS. 16A to 16C, both the transmitted reflected power and the received power variation increase depending on the distance. In an antenna in which a change in transmitted reflected power due to the proximity of the body is relatively small, a change in transmitted reflected power is small but a change in received power is large as compared with the change in transmitted reflected power.

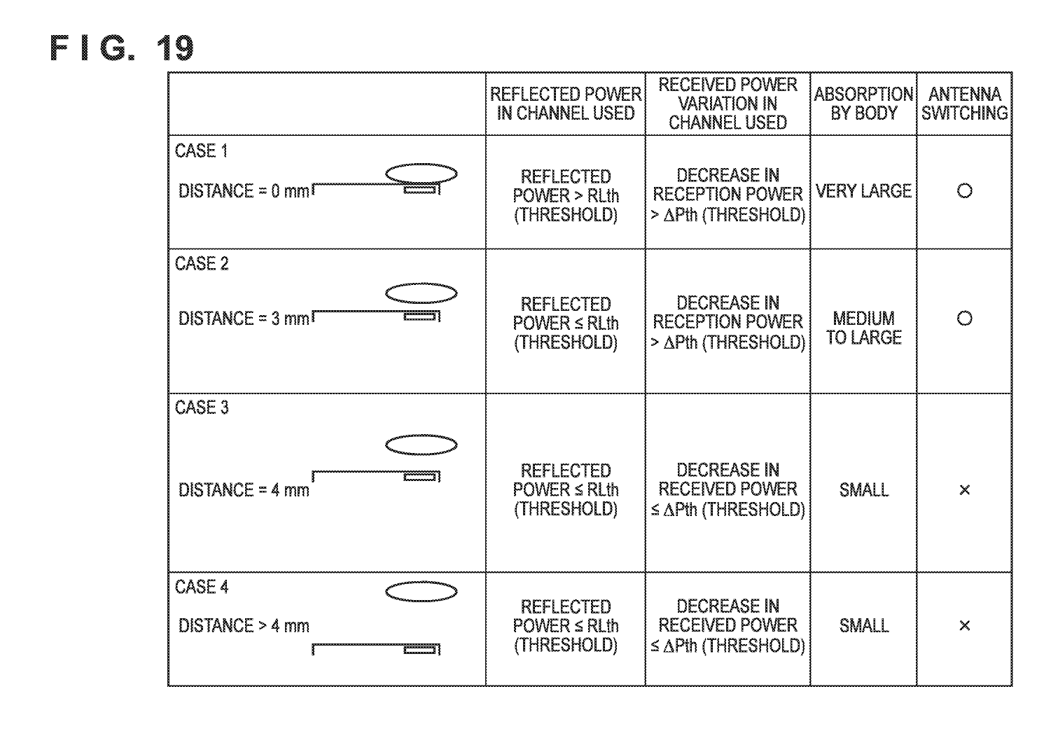

FIG. 19 is a table showing antenna switching conditions when an antenna in which a change in transmitted reflected power due to the proximity of the body is relatively small is used, and the body moves close to the exterior covering of the housing of the wireless apparatus from above the antenna. The table of FIG. 19 shows cases 1 to 4 in descending order of the degree of proximity of the body to the exterior covering of the housing from top to bottom.

The table shows, from left to right, a transmitted reflected power in a channel used, a received power variation in the channel used, the absorption degree of a radio wave by the body, and an antenna switching determination result (◯x). Assume that the received power of the channel used in the initial state in which an antenna switching determination operation starts is at a sufficient level to ensure the communication quality, and is equal to or larger than Pth. If the received power P0 is smaller than Pth, an antenna switching operation is performed to ensure the communication quality irrespective of the values of the transmitted reflected power and received power variation.

In case 1, the distance between the exterior covering and the body is 0 mm, and the transmitted reflected power and the received power variation exceed the thresholds RLth and ΔPth, respectively. In this case, the absorption degree of the radio wave by the body is highest, and it is thus determined to switch the antenna.

In case 2, the distance between the exterior covering and the body is 3 mm. The body is not in contact with the exterior covering of the housing but is sufficiently close to it. Although the transmitted reflected power does not exceed the transmitted reflected power threshold RLth, the received power variation exceeds the threshold ΔPth. In this case, although the body is close to the exterior covering, the transmitted reflected power is small. Since, however, it is determined that the received power variation is large and the absorption degree of the radio wave by the body is high, it is determined to switch the antenna.

In case 3, the distance between the exterior covering and the body is 4 mm and the transmitted reflected power does not exceed the threshold RLth. Since the received power variation does not exceed the threshold ΔPth, either, it is determined not to switch the antenna.

In case 4, the distance between the exterior covering and the body is longer than 4 mm, and the transmitted reflected power does not exceed the threshold RLth similarly to case 3. Since the received power variation does not exceed the threshold ΔPth, either, it is determined not to switch the antenna.

To make these determinations, whether a time is equal to or longer than a predetermined time To and, whether the transmitted reflected power or the received power variation exceeds the corresponding threshold may be added as a condition. The predetermined time To for detecting the transmitted reflected power can be different from that for detecting the received power variation.

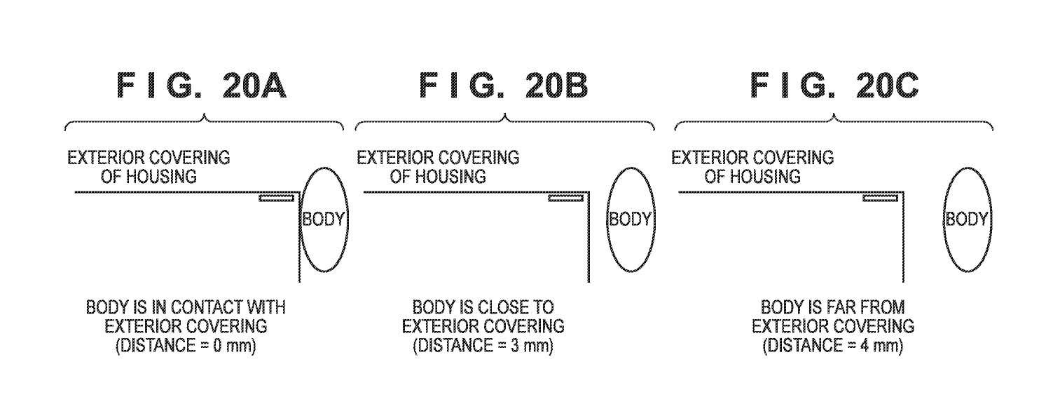

A case wherein an antenna in which a change in transmitted reflected power due to the proximity of the body is relatively small is used, and the body moves close to the exterior covering of the housing of the wireless apparatus in the horizontal direction in which its influence on the antenna is small will be described with reference to FIGS. 20A to 20C. FIG. 20A shows a case in which the body is in direct contact with the exterior covering of the housing. FIG. 20B shows a case in which the degree of proximity of the body to the housing is relatively low. FIG. 20C shows a case in which the degree of proximity is low.

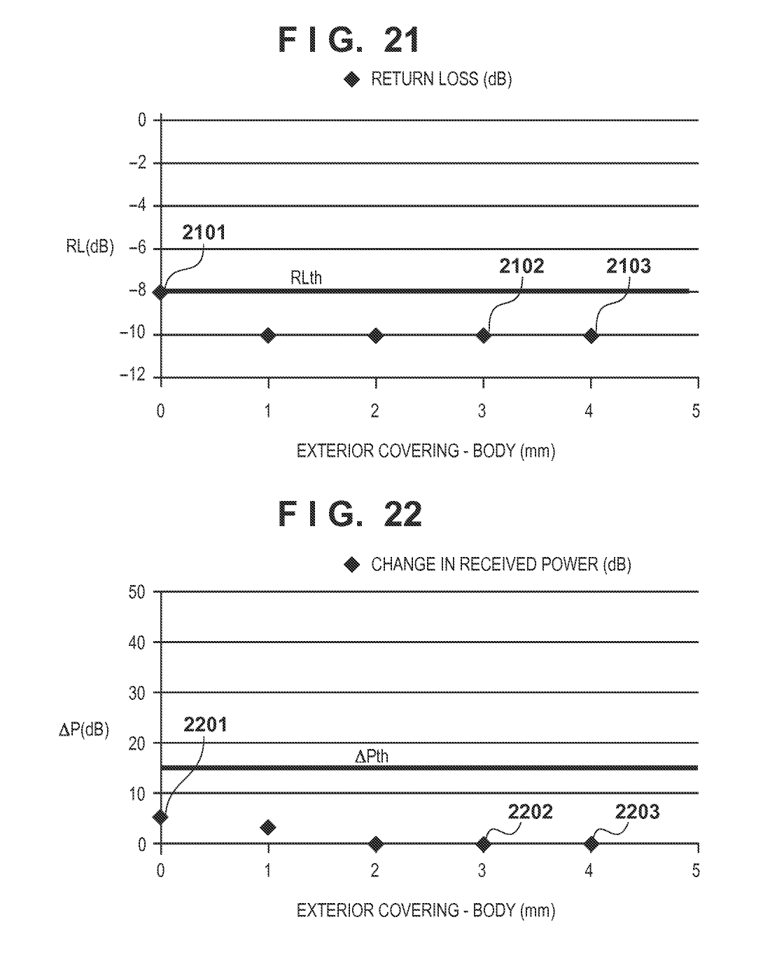

Referring to FIG. 21, the abscissa represents the distance between the body and the exterior covering of the housing as the degree of proximity of the body to the exterior covering, and the ordinate represents the transmitted reflected power. Points 2101, 2102, and 2103 of FIG. 21 correspond to the states shown in FIGS. 20A, 20B, and 20C, respectively. Referring to FIG. 21, when the body is relatively far from the exterior covering of the housing, that is, the distance is 4 mm, the transmitted reflected power is −10 dB. When the body is relatively close to the exterior covering, that is, the distance is 3 mm, the transmitted reflected power is also −10 dB. When the body is in contact with the exterior covering, that is, the distance is 0 mm, the transmitted reflected power is −8 dB.

Assume that the transmitted reflected power RLth=−8 dB obtained when the distance between the body and the exterior covering of the housing is 0 mm is set as a transmitted reflected power threshold. If the transmitted reflected power is equal to or larger than the threshold, it is determined that there is the influence of the body and a radio wave radiates the body, thereby performing an operation of switching the antenna in use to another antenna. The transmitted reflected power is equal to the threshold RLth=−8 dB only if the body is in almost contact with the exterior covering. In such case, determination using only the transmitted reflected power may be insufficient. A change in received power is, therefore, detected to perform an antenna switching determination operation.

Points 2201, 2202, and 2203 of FIG. 22 correspond to the states shown in FIGS. 20A, 20B, and 20C, respectively. FIG. 22 is a graph schematically showing the relationship between the degree of proximity of the body to the exterior covering of the housing of the wireless apparatus and a decrease in received power of an incoming radio wave. Referring to FIG. 22, the abscissa represents the distance between the exterior covering and the body, and the ordinate represents a variation of the received power with respect to that in the normal use state when the body which is not close to the antenna moves close to it. The received power variation is 0 dB when the body is at a relatively long distance of 4 mm from the exterior covering of the housing. The received power variation (a decrease) is also 0 dB when the body is at a relatively short distance of 3 mm. The received power variation is 5 dB when the body is in almost contact with the exterior covering, that is, the distance is 0 mm.

For the antenna in which a change in transmitted reflected power due to the proximity of the body is large as shown in FIGS. 11A to 11C, even if the body moves close to the antenna in the horizontal direction in which the influence on the antenna is small, the transmitted reflected power increases and the received power variation also increases depending on the distance, albeit slightly. For the antenna in which a change in transmitted reflected power due to the proximity of the body is small, however, if the body moves close to the antenna in the horizontal direction in which the influence on the antenna is small, both the transmitted reflected power and the received power change only by a small amount depending on the distance. In this case, an antenna switching operation is performed only when the transmitted reflected power exceeds the threshold and the body is in almost contact with the exterior covering, that is, the distance is 0 mm, as shown in FIG. 21.

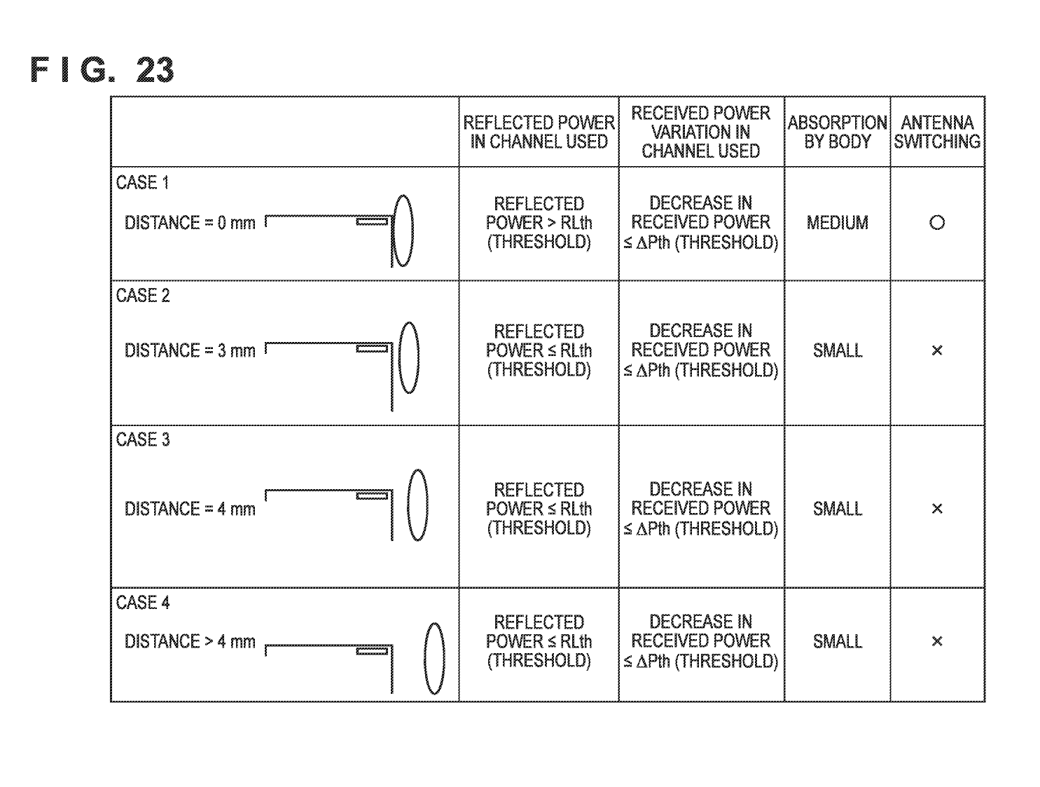

FIG. 23 is a table showing antenna switching conditions when an antenna in which a change in transmitted reflected power due to the proximity of the body is relatively small is used, and the body moves close to the exterior covering of the housing of the wireless apparatus in the horizontal direction in which the influence on the antenna is small. The table of FIG. 23 shows cases 1 to 4 in descending order of the degree of proximity of the body to the exterior covering of the housing from top to bottom.

The table shows, from left to right, transmitted reflected power in a channel used, a received power variation in the channel used, the absorption degree of a radio wave by the body, and an antenna switching determination result (◯x). Assume that the received power P0 of the channel used in the initial state in which an antenna switching determination operation starts is at a sufficient level to ensure the communication quality, and is equal to or larger than Pth. If the received power P0 is smaller than Pth, an antenna switching operation is performed to ensure the communication quality irrespective of the values of the transmitted reflected power and received power variation.

In case 1, the distance between the exterior covering and the body is 0 mm, and the transmitted reflected power exceeds the threshold RLth, thereby determining that the body is close to the exterior covering. Although the received power variation is equal to or smaller than the threshold ΔPth, the absorption degree of a radio wave by the body is at a middle level, thereby determining to switch the antenna.

In case 2, the distance between the exterior covering and the body is 3 mm. The body is not in contact with the exterior covering of the housing but is sufficiently close to it. Since, however, the transmitted reflected power does not exceed the threshold RLth and also the received power variation is equal to or smaller than the threshold ΔPth, it is determined that the absorption degree of a radio wave by the body is low, and an antenna switching operation is not performed. This determination is made based on the fact that the radiation direction of a planar patch antenna is the upper direction of a radiator and, therefore, the radiation of a radio wave in a side direction is thus relatively weak, with the result that the influence of the proximity of the body on the transmitted reflected power and the amount of radiation to the body are relatively small.

In case 3, the distance between the exterior covering and the body is 4 mm and the transmitted reflected power does not exceed the threshold RLth. Since the received power variation does not exceed the threshold ΔPth, either, it is determined not to switch the antenna.

In case 4, the distance between the exterior covering and the body is longer than 4 mm, and the transmitted reflected power does not exceed the threshold RLth similarly to case 3. Since the received power variation does not exceed the threshold ΔPth, either, it is determined not to switch the antenna.

In the above cases, whether a time is equal to or longer than a predetermined time and whether the transmitted reflected power exceeds the threshold may be added as a condition.

Furthermore, the antenna and a sensor for detecting contact may cooperate with each other to perform a detection operation. A sensor is arranged near each antenna to detect contact of an object at a predetermined position from the antenna. A case in which the sensor detects contact indicates that the distance is 0 mm. In this case, it is determined to switch the antenna. A sensor which can detect contact of an object, such as that for detecting a change in capacitance can be used. If the sensor detects contact, it is possible to switch the antenna irrespective of the values of the transmitted power and received power variation, thereby enabling to solve failure of determination.

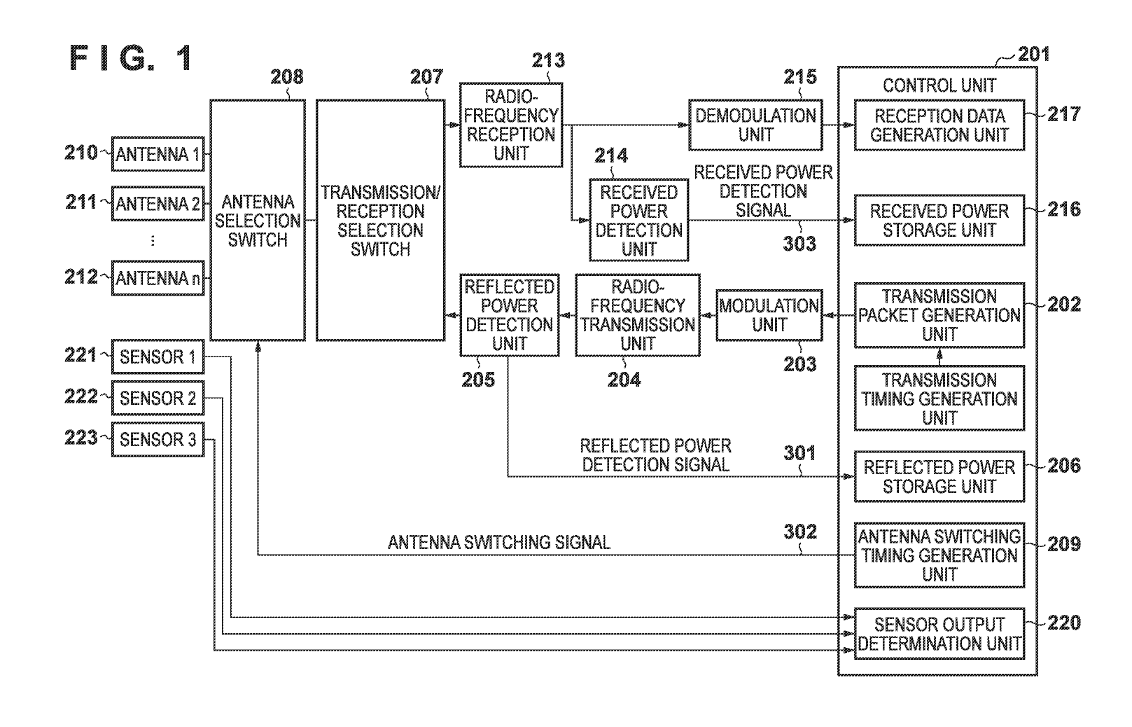

The wireless communication apparatus for performing an antenna switching operation according to the present invention will be schematically described with reference to FIG. 1. The wireless communication apparatus includes a plurality of antennas 210, 211, . . . , 212. The wireless communication apparatus includes at least one wireless communication circuit according to a plurality of frequencies or schemes. A control unit 201 sends an antenna switching signal 302 based on a reflected power detection signal 301 from a reflected power detection unit 205 and a received power detection signal 303 from a received power detection unit 214. In response to an instruction by the antenna switching signal 302, an antenna selection switch 208 operates to switch an antenna.

In a transmission operation, a transmission packet generation unit 202 of the control unit 201 supplies transmission data as a packet to a modulation unit 203. The modulation unit 203 executes a desired modulation operation, and supplies a modulation signal to a radio-frequency transmission unit 204. The radio-frequency transmission unit 204 performs a frequency conversion operation and a desired amplification operation. A radio-frequency signal output from the radio-frequency transmission unit 204 is supplied to a transmission/reception selection switch 207 via the reflected power detection unit 205. The transmission/reception selection switch 207 is connected with one of the antennas 210, 211, . . . , 212 by the antenna selection switch 208. The antenna selection switch 208 is controlled by the antenna switching signal 302 from an antenna switching timing generation unit 209 of the control unit 201 to select one of the antennas 210, 211, . . . , 212.

The reflected power detection unit 205 is formed by a directional coupler and the like, and is used to detect a transmitted reflected power from the selected antenna through the antenna selection switch 208 and transmission/reception selection switch 207. The detected transmitted reflected power is stored in a reflected power storage unit 206 of the control unit 201 as the reflected power detection signal 301. The reflected power storage unit 206 may store a transmitted reflected power threshold in advance.

In a reception operation, the reception signal received by the antenna undergoes a desired amplification operation and frequency conversion operation by a radio-frequency reception unit 213, and is supplied to a demodulation unit 215. The demodulation unit 215 executes a demodulation operation. Demodulated data is sent to a reception data generation unit 217, and is also supplied to the received power detection unit 214, which then stores the data as the received power detection signal 303 in a received power storage unit 216 of the control unit 201. The received power storage unit 216 may store a received power variation threshold in advance.

Each of sensors 221, 222, 223, . . . arranged adjacent to the antennas 210, 211, . . . , 212 is used to detect contact of an object in proximity to each antenna. The sensor detects contact by, for example, detecting a change in capacitance. Based on the detection result of each sensor, a sensor output determination unit 220 of the control unit 201 determines whether the apparatus is in contact with the object.

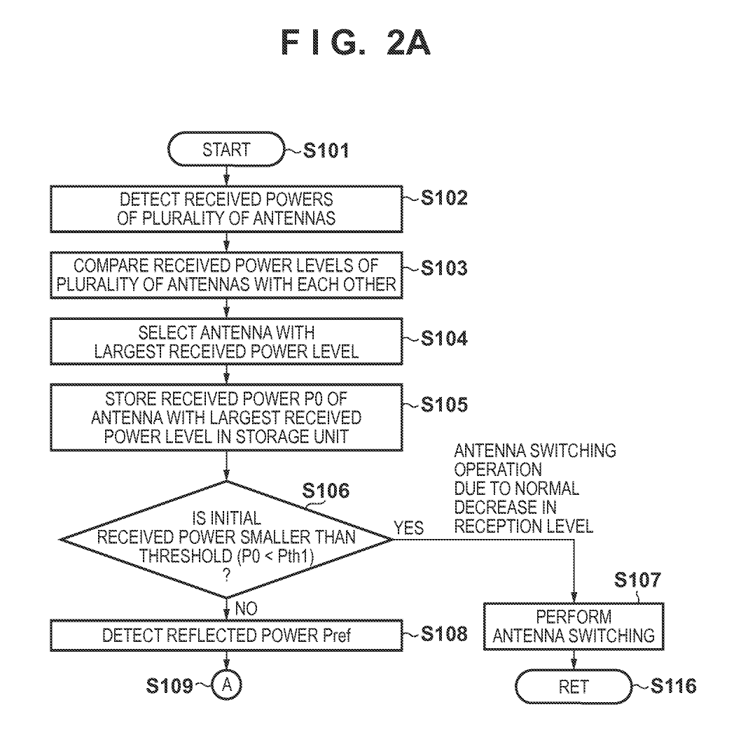

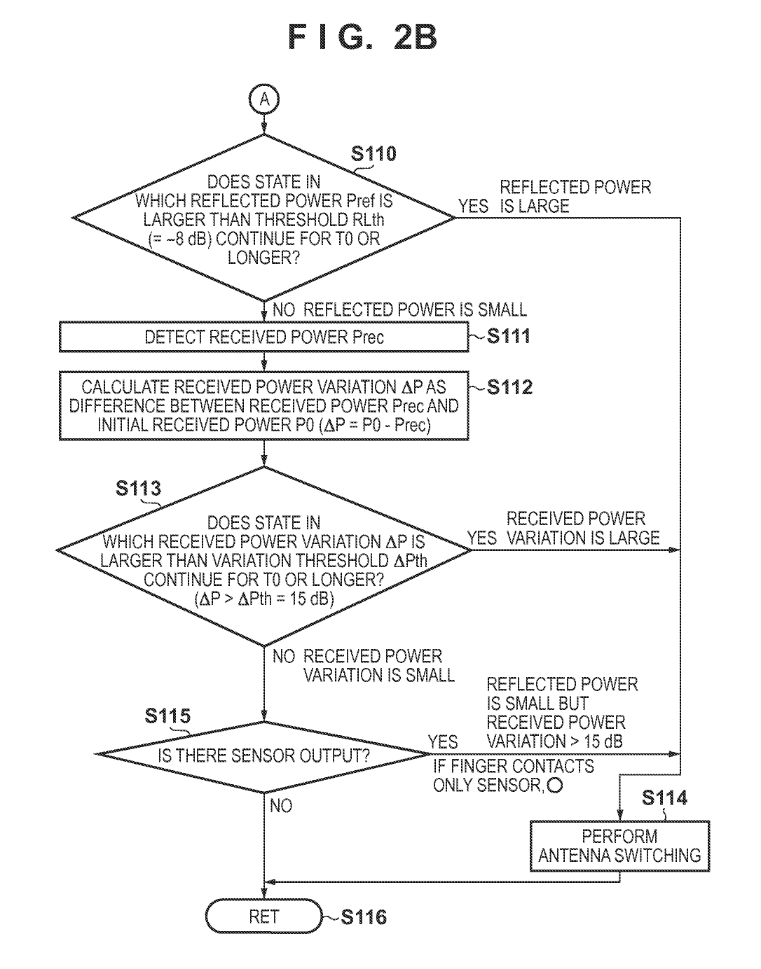

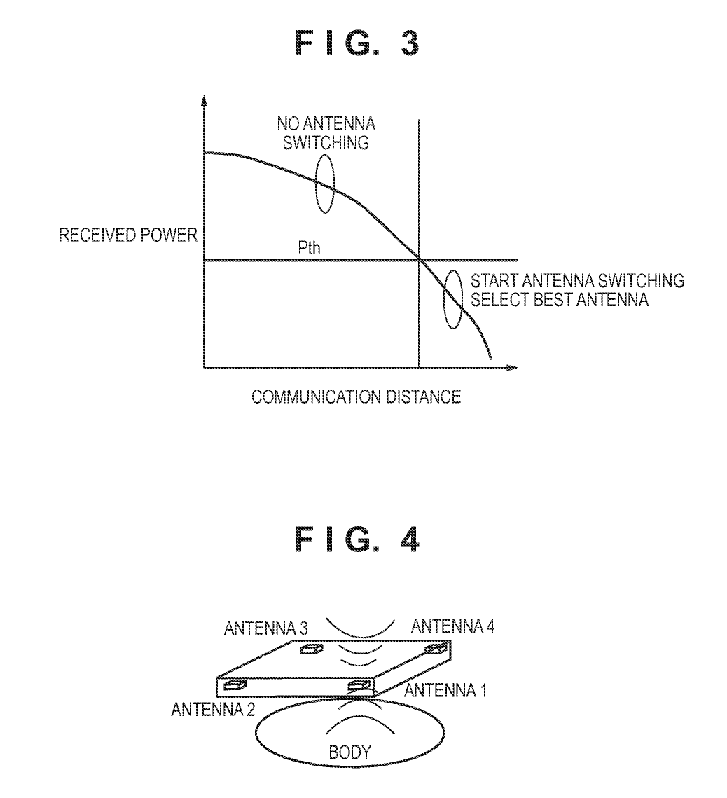

FIGS. 2A and 2B are flowcharts for explaining an antenna switching timing operation according to the present invention. A routine for determining whether to perform an antenna switching operation starts (step S101). The received power detection unit 214 detects the initial received powers of all the antennas (step S102). The control unit 201 compares the received power levels of the plurality of antennas with each other (step S103). The antenna switching timing generation unit 209 outputs the antenna switching signal 302 to the antenna selection switch 208, and selects an antenna with a largest received power level (step S104).

The control unit 201 stores the initial received power P0 of the selected antenna in the received power storage unit 216 (step S105). The control unit 201 then compares the initial received power P0 with the received power threshold Pth stored in advance in the storage unit. If the initial received power P0 is smaller than Pth, the control unit 201 determines that the reception level of the antenna is low (step S106), and controls the antenna selection switch 208 to switch the antenna in use to another antenna (step S107). If P0≧Pth, the control unit 201 determines that the reception level is sufficiently high, and the process advances to a next step (step S108).

In the next step, the reflected power detection unit 205 detects a reflected power Pref of transmitted output power (step S108). The control unit 201 compares the reflected power Pref with the transmitted reflected power threshold RLth stored in advance in the storage unit. If Pref is equal to or larger than RLth, the control unit 201 determines that the degree of proximity of the body is high. After that, the control unit 201 determines whether the state continues for a predetermined time To or longer (step S110). If the state continues for the predetermined time To or longer, the control unit 201 controls the antenna selection switch 208 to switch the antenna in use to another antenna (step S114).

Note that the transmitted reflected power threshold RLth is about 20% of the transmitted power. If Pref<RLth, the control unit 201 determines that the reflected power level is low, and detects a current received power Prec in a next step (step S111). A difference ΔP between the initial received power P0 and the current received power Prec (ΔP=P0−Prec) is calculated, and is set as a received power variation (step S112). The control unit 201 compares the received power variation ΔP with the received power variation threshold ΔPth stored in advance in the storage unit. If ΔP≧ΔPth, the received power variation is large, thereby determining that the degree of the proximity of the body is high (step S113). If this state continues for the predetermined time, the control unit 201 controls the antenna selection switch 208 to switch the antenna in use to another antenna (step S114). If ΔP<ΔPth, the received power variation is small, and thus the control unit 201 determines that the degree of proximity of the body is low. The process then advances to a next step. Note that the received power variation threshold ΔPth is about 15 dB.

The control unit 201 outputs the detection results of the sensors 221 to 223 arranged near the antennas in the next step (step S115). If there is the detection result of the sensor arranged near the antenna in use, the control unit 201 determines that there is a small change in received power but part of the body is in contact with the apparatus near the antenna. In this case, based on the determination that the body is in contact with the apparatus, the control unit 201 controls the antenna selection switch 208 to switch the antenna in use to another antenna (step S114). If there is no sensor output, the control unit 201 determines that the body is not in contact with the apparatus (step S115). It is possible to repeatedly execute the above determination procedure.

Although in the above description, the same predetermined time is used as the detection times in steps S110 and S113, different times may be used. It is highly probable that the body is close to the antenna when the reflected power Pref exceeds the threshold as compared with a case in which the received power variation ΔP exceeds the threshold. It is therefore possible to reduce the amount of radiation of a radio wave to the body at a higher probability by making the time taken for the determination operation in step S110 shorter than that taken for the determination operation in step S113.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

As described above, according to the embodiments, the proximity of a body to a housing is detected by detecting a transmitted reflected power and the amount of received power, and an antenna in use is switched to another antenna. It is possible to reduce the mutual influence of the body and antenna without increasing the scale of a circuit around the antenna.

A method of considering only a change in received power may not be able to detect the proximity of a body. By adding the amount of the transmitted reflected power and the presence/absence of a sensor output as determination conditions, however, it is possible to detect the proximity of the body, and prevent radiation of a radio wave to the body. If the transmitted reflected power is small but a change in received power is large, it is determined that the body is close to the antenna, thereby enable to prevent radiation of a radio wave to the body. It is possible to prevent radiation of a radio wave to the body as compared with a method using only the transmitted reflected power as a determination condition. In a method using only a sensor output as a determination condition, it is possible to detect only contact of the body with the housing but it is possible to detect the proximity of the noncontact body by detecting a change in transmitted reflected power and that in received power.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-276126 filed Dec. 16, 2011 and No. 2012-212967 filed Sep. 26, 2012, which are hereby incorporated by reference herein in their entirety.

what is claimed is:

1. A wireless communication apparatus for performing wireless communication using an antenna selected from a plurality of antennas comprising:
a received power detection unit which detects received power received by an antenna selected from the plurality of antennas;
a reflected power detection unit which detects transmitted reflected power of the selected antenna; and
a switching unit which switches an antenna used for communication to another antenna based on a variation of the received power detected by the received power detection unit and an amount of electric power of the reflected power detected by the reflected power detection unit.

2. The apparatus according to claim 1, wherein when the variation of the received power detected by the received power detection unit exceeds a first threshold, the switching unit switches the antenna used for communication to another antenna.

3. The apparatus according to claim 1, wherein when the reflected power detected by the reflected power detection unit exceeds a second threshold, the switching unit switches the antenna used for communication to another antenna.

4. The apparatus according to claim 1, further comprising
a contact detection unit which detects contact of an object at a predetermined position from the selected antenna on a housing of the wireless communication apparatus,
wherein when the contact detection unit detects contact of an object, the switching unit switches the antenna used for communication to another antenna.

5. A wireless communication apparatus for performing wireless communication using an antenna selected from a plurality of antennas comprising:
a received power detection unit which detects received power received by an antenna selected from the plurality of antennas;
a contact detection unit which detects contact of an object at a predetermined position from the selected antenna on a housing of the wireless communication apparatus; and
a switching unit which switches an antenna used for communication to another antenna based on a variation of the received power detected by the received power detection unit and a contact detection result of the contact detection unit.

6. A control method for a wireless communication apparatus for performing wireless communication using an antenna selected from a plurality of antennas comprising:
a step of switching a selected antenna to another antenna based on a variation of received power received by the selected antenna and an amount of electric power of transmitted reflected power of the selected antenna.

7. A control method for a wireless communication apparatus for performing wireless communication using an antenna selected from a plurality of antennas comprising:
a step of switching an antenna used for communication to another antenna based on a variation of received power received by a selected antenna and a detection result of detecting contact of an object at a predetermined position from the selected antenna on a housing of the wireless communication apparatus.

8. A non-transitory computer-readable recording medium recording a program for causing a computer to execute each step of a control method according to claim 6.

9. A non-transitory computer-readable recording medium recording a program for causing a computer to execute each step of a control method according to claim 7.
